(19) United States
(12) Patent Application Publication
(10) Pub. No.: US 2016/0289447 A1
(43) Pub. Date: Oct. 6, 2016

(54) UTILIZATION OF FLAX FIBERS AND GLASS FIBERS IN A BIO-BASED RESIN

(71) Applicant: NDSU RESEARCH FOUNDATION, Fargo, ND (US)

(72) Inventors: Dean C. WEBSTER, Fargo, ND (US); Thomas J. NELSON, St. Paul, MN (US); Nassibeh HOSSEINI, Fargo, ND (US); Chad A. ULVEN, Walcott, ND (US)

(21) Appl. No.: 15/036,180

(22) PCT Filed: Nov. 18, 2014
(86) PCT No.: PCT/US2014/066073

§ 371 Date: May 12, 2016

Related U.S. Application Data
(60) Provisional application No. 61/905,566, filed on Nov. 18, 2013.

(51) Int. Cl. C08L 75/08; C08J 5/04; C08G 18/36; C08K 7/14

(52) U.S. Cl. CPC C08L 75/08; C08K 7/14; C08J 5/043; C08J 5/045; C08G 18/36; C08J 2375/08; C08J 2401/02

(57) ABSTRACT

The invention provides structural biocomposites comprising cellulose-based bast natural fibers, glass fibers, or mixtures thereof, and polyurethanes. The polyurethanes are synthesized from the reaction of polyfunctional bio-based polyols with polyisocyanates. The resultant polyurethanes have higher moduli, hardness, and Tg compared to other bio- and petroleum-based polyols. Methods of making the structural biocomposites are also disclosed.

### CROSS-REFERENCE TO RELATED APPLICATIONS

This application claims priority to U.S. Application 61/905,566, filed Nov. 18, 2013, which is incorporated herein by reference.

### FIELD OF THE INVENTION

This invention relates to structural biocomposites comprising cellulose-based bast natural fibers, glass fibers, or mixtures thereof, and polyurethanes, in which the polyurethanes are synthesized from the reaction of polyfunctional bio-based polyols and polyisocyanates.

### BACKGROUND

In recent years, the utilization of bio-based materials either as a bio-based resin or natural fibers in composites has emerged due to the need for better chemical sustainability. In addition, the sustainable use of chemicals has a potential positive impact on the environment. Moreover, the north portion of the USA is a rich source of renewable resources; therefore, developing polymers from cheap and renewable resources is cost effective. Some other advantages of using renewable resources in composite industry included: less dependence on petroleum-based products and higher specific strength and stiffness.

Polyurethanes (PUs) are usually made from petroleum based polyols and isocyanates and have widespread applications in automotive parts, coatings, sealants, adhesives, and other infrastructure uses. See Szycher, Szycher's Handbook of Polyurethanes, Boca Raton: CRC Press (1999). Today, polyurethanes are finding a growing interest for applications as composites due to the increasing demand for lightweight, durable, and cost effective compounds for sectors such as the automotive market. See A. International Symposium on Polymer, J. E. Kresta, and M. American Chemical Society, “Polymer additives,” New York. Owing to the versatility of polyurethane chemistry, a broad range of properties and applications are possible for reinforced composites, such as seat frames, sun shades, door panels, package trays, and truck box panels. Adhesion between the polyurethane matrix and the fiber surface is also an important factor in the improvement of mechanical performances. See Kau et al., “Damage Processes in Reinforced Reaction Injection Molded Polyurethanes,” Journal of Reinforced Plastics and Composites 8:18-39 (1989). Petrochemical-based polyester, polyether, and acrylic polyols are the main types of polyols used in PUs, but interest in plant oil-based polyols is growing. See Pan et al., “New Biobased High Functionality Polyols and Their Use in Polyurethane Coatings,” ChemSusChem 5:419-429 (2012); Nelson et al., “Bio-Based High Functionality Polyols and Their Use in 1K Polyurethane Coatings,” Journal of Renewable Materials 1:141-153 (2013); Dwan'isa et al., “Novel soy oil based polyurethane composites: Fabrication and dynamic mechanical properties evaluation,” Journal of Materials Science 39:1887-1890 (2004).

Natural oils are a rich source of polymer precursors with broad ranges of properties. The wide ranges of properties in bio-based polymer are attributed to different types of functionalities of polymer precursors such as double bond and ester groups. Epoxidation is one of the most important functionalization reactions of double bonds, and epoxide ring-opening reactions can lead to numerous products. See Baumann et al., “Natural fats and oils—renewable raw-materials for the chemical-industry,” Angewandte Chemie-International Edition in English 27:41-62 (1988). On the other hand, the modification of double bonds can incorporate the functionalities like maleates, hydroxyl, or epoxy. See Khot et al., “Development and application of triglyceride-based polymers and composites,” Journal of Applied Polymer Science 82:703-723 (2001); Mosiewicki et al., “Polyurethane Foams Obtained from Castor Oil-based Polyol and Filled with Wood Flour,” Journal of Composite Materials 43:3057-3072 (2009); Wik et al., “Castor Oil-based Polyurethanes Containing Cellulose Nanocrystals,” Polymer Engineering and Science 51:1389-1396 (2011); La Scala et al., “Effect of FA composition on epoxidation kinetics of TAG,” Journal of the American Oil Chemists Society 79:373-378 (2002). In the last decade, the development of bio-based polyols made from natural oils has received focused attention in polymer production. Hydroxyl-containing polyols and isocyanates are the two major components of polyurethane. Therefore, developing the bio-based polyol for polyurethane manufacturing is also preferable due to economic and environmental issues.

Desroches' review on vegetable oil derived bio-polyurethanes presents a detailed overview of different possible synthetic routes and includes a useful list of commercial bio-based polyols that can be applied in the production of polyurethanes. See Desroches et al., “From Vegetable Oils to Polyurethanes: Synthetic Routes to Polyols and Main Industrial Products,” Polymer Reviews 52:38-79 (2012). Indeed, castor oil, a hydroxyl-containing triglyceride and other plant oils have been used for making polyol functional compounds. See Mallu et al., “Synthesis and characterization of castor oil based polyurethane-polyacrylonitrile interpenetrating polymer networks,” Bulletin of Materials Science 23:413-418 (2000). Castor oil was the first natural oil that was used for making bio-based polyols. Several works have reported on the use of alcoholyzed castor oil for the production of polyurethanes obtained by polycondensation reactions with different isocyanate components. See Wik et al., “Castor Oil-based Polyurethanes Containing Cellulose Nanocrystals,” Polymer Engineering and Science 51:1389-1396 (2011); Hu et al., “Rigid polyurethane foam prepared from a rape seed oil based polyol,” Journal of Applied Polymer Science 84:591-597 (2002). The polyurethane made from castor oil is relatively soft since the number of hydroxy groups per molecule is relatively low with only 2.7 per molecule on average. To improve the mechanical properties of polyurethane, higher functionalities of polyol is needed. See Nelson et al., “Bio-Based High Functionality Polyols and Their Use in 1K Polyurethane Coatings,” Journal of Renewable Materials 1:141-153 (2013); Pan et al., “New Biobased High Functionality Polyols and Their Use in Polyurethane Coatings,” ChemSusChem 5:419-429 (2012). Among all of the available plant oils, soybean oil-based polyols are more desirable because they provide higher functionalities of polyol and result in better mechanical properties compared to other plant oil polyols. Moreover, it can be produced in large production volume abundance (ca. 70 million metric tons/year in USA) and low price (ca. 0.1 US 5/kg). Khot et al. utilized an acrylated epoxidized soybean oil to produce glass fiber composites by resin transfer molding. See Khot et al., “Development and application of triglyceride-based polymers and composites,” Journal of Applied Polymer Science 82:703-723 (2001). Depending on the fiber content, young's moduli of 5.2 to 24.8 GPa were measured for the composites bearing 35 and 50 wt. % of GF, respectively, and tensile strengths of 129-463 MPa, for the same samples.

A common method to produce a bio-based polyol with higher functionalities is presented by previous researchers. See Pan et al., “New Biobased High Functionality Polyols and Their Use in Polyurethane Coatings,” ChemSusChem 5:419-429 (2012); Nelson et al., “Bio-Based High Functionality Polyols and Their Use in 1K Polyurethane Coatings,” Journal of Renewable Materials 1:141-153 (2013); Pan et al., “High Biobased Content Epoxy-Anhydride Thermosets from Epoxidized Sucrose Esters of Fatty Acids,” Biomacromolecules 12:2416-2428 (2011). Two reaction steps in this method are epoxidization of soybean oil and then ring-opening with an active hydrogen molecule. However, a polyfunctional epoxidized sucrose soyate polyol called methoxylated sucrose soyate polyol (MSSP) may also be made. When the ring-opening of epoxidized sucrose soyate (ESS) is accomplished using methanol, the resultant polyol is called MSSP. The schematic chemical structure of the MSSP is shown in FIG. 1. The use of an epoxidized sucrose ester of soybean oil gives even higher hydroxyl functionality and as a result, it provides superior properties compared to epoxidized soybean oil. See Nelson et al., “Bio-Based High Functionality Polyols and Their Use in 1K Polyurethane Coatings,” Journal of Renewable Materials 1:141-153 (2013).

While it is known that this high hydroxyl group functionality polyol provides greater hardness and range of cross-link density to PU thermosets in coatings applications (see Pan et al., “New Biobased High Functionality Polyols and Their Use in Polyurethane Coatings,” ChemSusChem 5:419-429 (2012); Nelson et al., “Bio-Based High Functionality Polyols and Their Use in 1K Polyurethane Coatings,” Journal of Renewable Materials 1:141-153 (2013)), the potential application of this novel bio-polyol in polyurethane reinforcing composites has not been explored yet.

### SUMMARY OF THE INVENTION

This invention relates to structural biocomposites comprising cellulose-based bast natural fibers, glass fibers, or mixtures thereof, and polyurethanes, in which the polyurethanes are synthesized from the reaction of polyfunctional bio-based polyols and polyisocyanates. The polyurethanes synthesized from the reaction of polyfunctional bio-based polyols and polyisocyanates have shown higher moduli, hardness, and T_{g} compared to another bio-based and petroleum-based polyols. See Pan et al., “New Biobased High Functionality Polyols and Their Use in Polyurethane Coatings,” ChemSusChem 5:419-429 (2012); Nelson et al., “Bio-Based High Functionality Polyols and Their Use in 1K Polyurethane Coatings,” Journal of Renewable Materials 1:141-153 (2013). In one embodiment, the cellulose-based bast natural fiber may be selected from flax fibers because they possess moderate strength and low density. See Wool et al., Bio-based polymers and composites: Academic Press (2005). Moreover, in comparison to other natural fibers, they are more readily available.

Methods of making of the structural biocomposites are separate embodiments of the invention.

### BRIEF DESCRIPTIONS OF THE FIGURES

FIG. 1 depicts the schematic chemical structure of the methoxylated sucrose soyate polyol (MSSP).

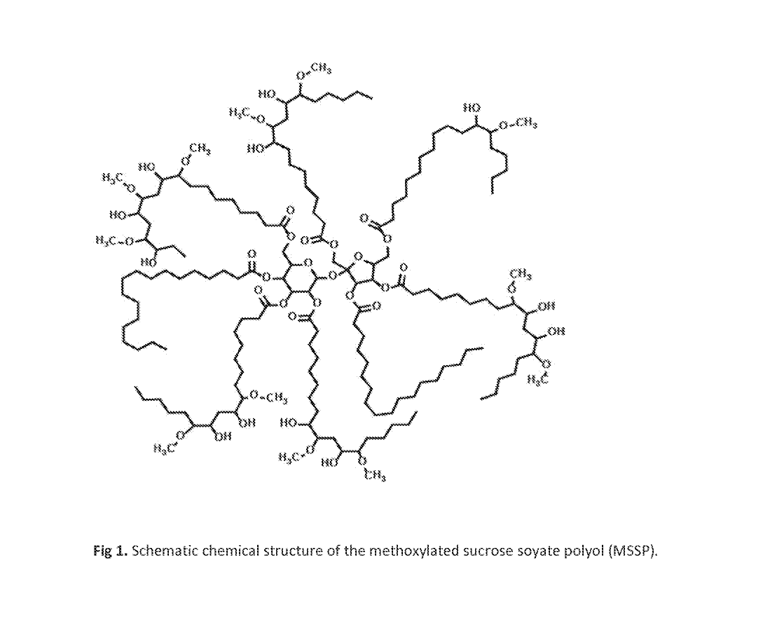

FIG. 2 depicts DSC curves at 10° C./min for neat MSSP PU system curing.

FIG. 3 provides a graph of temperature dependence of the storage modulus (G′) of MSSP based polyurethane composites: (A) neat polyurethane, (B) flax reinforced (40 vol %) and (C) glass reinforced (50 vol %).

FIG. 4 provides a graph of glass transition temperature (T_{g}) of MSSP based polyurethane composites: (A) neat polyurethane, (B) flax reinforced (40 vol %) and (C) glass reinforced (50 vol %).

### DESCRIPTION OF THE INVENTION

This invention relates to structural biocomposites comprising cellulose-based bast natural fibers, glass fibers, or mixtures thereof, and polyurethanes, in which the polyurethanes are synthesized from the reaction of polyfunctional bio-based polyols and polyisocyanates.

In one embodiment, the polyfunctional bio-based polyols may be prepared by epoxide ring-opening reactions from epoxidized polyol esters of fatty acids (EPEFA's) in which secondary hydroxyl groups may be generated from epoxides on fatty acid chains in the manner described in Pan et al., “New Biobased High Functionality Polyols and Their Use in Polyurethane Coatings,” ChemSusChem 5:419-429 (2012), and WO 2011/097484, which are incorporated herein by reference.

In one embodiment, an EPEFA that may be used in the invention can be synthesized by the reaction of a polyol having four or more hydroxyl groups; and an ethylenically unsaturated fatty acid, optionally a saturated fatty acid, or mixtures thereof; where at least one ethylenically unsaturated group of the ethylenically unsaturated fatty acid is oxidized to an epoxy group. For example, an EPEFA may be synthesized from the epoxidation of vegetable or seed oil esters of polyols having four or more hydroxyl groups/molecule.

Polyol esters of fatty acids containing four or more vegetable oil fatty acid moieties per molecule can be synthesized by the reaction of polyols with four or more hydroxyl groups per molecule with either a mixture of fatty acids or esters of fatty acids with a low molecular weight alcohol, as is known in the art. The former method is direct esterification while the latter method is transesterification. A catalyst may be used in the synthesis of these compounds. Epoxide groups may then be introduced in the polyol esters of fatty acids by oxidation of the vinyl groups in the vegetable oil fatty acid to form EPEFA's. The epoxidation may be carried out using reactions known in the art for the oxidation of vinyl groups with in situ epoxidation with peroxyacid being a preferred method.

Polyols having at least four hydroxyl groups per molecule suitable for the process include, but are not limited to, pentaerithritol, di-trimethylolpropane, di-pentaerithritol, tri-pentaerithitol, sucrose, glucose, mannose, fructose, galactose, raffinose, and the like. Polymeric polyols can also be used including, for example, copolymers of styrene and allyl alcohol, hyperbranched polyols such as polyglycidol and poly(dimethylpropionic acid), and the like. Comparing sucrose to glycerol, there are a number of advantages for the use of a polyol having more than four hydroxyl groups/molecule including, but not limited to, a higher number of fatty acids/molecule; a higher number of unsaturations/molecule; when epoxidized, a higher number of oxiranes/molecule; and when crosslinked in a coating, higher crosslink density.

The degree of esterification may be varied. The polyol may be fully esterified, where substantially all of the hydroxyl groups have been esterified with the fatty acid, or it may be partially esterified, where only a fraction of the available hydroxyl groups have been esterified. It is understood in the art that some residual hydroxyl groups may remain even when full esterification is desired. In some applications, as discussed below, residual hydroxyl groups may provide benefits to the resin. Similarly, the degree of epoxidation may be varied from substantially all to a fraction of the available double bonds. The variation in the degree of esterification and/or epoxidation permits one of ordinary skill to select the amount of reactivity in the resin, both for the epoxidized resins and their derivatives.

The hydroxyl groups on the polyols can be either completely reacted or only partially reacted with fatty acid moieties. Any ethylenically unsaturated fatty acid may be used to prepare a polyol ester of fatty acids to be used in the invention, with polyethylenically unsaturated fatty acids, those with more than one double bond in the fatty acid chain, being preferred. The Omega 3, Omega 6, and Omega 9 fatty acids, where the double bonds are interrupted by methylene groups, and the seed and vegetable oils containing them may be used to prepare polyol ester of fatty acids to be used in the invention. Mixtures of fatty acids and of vegetable or seed oils, plant oils, may be used in the invention. The plant oils, as indicated above, contain mixtures of fatty acids with ethylenically unsaturated and saturated fatty acids possibly present depending on the type of oil. Examples of oils which may be used in the invention include, but are not limited to, coconut oil, corn oil, castor oil, soybean oil, safflower oil, sunflower oil, linseed oil, tall oil fatty acid, tung oil, vernonia oil, and mixtures thereof. As discussed above, the polyol fatty acid ester may be prepared by direct esterification of the polyol or by transesterification as is known in the art. The double bonds on the fatty acid moieties may be converted into epoxy groups using known oxidation chemistry yielding EPEFA's.

In one embodiment, an EPEFA may undergo a ring-opening reaction with an organic acid in acid-epoxy reaction, as is known in the art, to introduce hydroxyl functionality and form the corresponding EPEFA polyol. Introducing hydroxyl functionality at an epoxy group using base-catalyzed acid-epoxy reactions is known in the art. Organic acids which may be used include, for example, acetic acid, propionic acid, butyric acid, isobutyric acid, 2-ethylhexanoic acid, and mixtures thereof. Small, C₁-C₁₂, organic acids such as these are generally preferred but others may also be used. As discussed above, a number of catalysts can be used to catalyze an acid-epoxy reaction and are reviewed in Blank et al., “Catalysis of the epoxy-carboxyl reaction,” J. Coat. Tech. 74:33-41 (2002). Bases known to catalyze acid-epoxy reactions, such as 1,8-diazabicyclo[5.4.0]undec-7-ene (DBU), triethyl amine, pyridine, potassium hydroxide and the like may be used. Quaternary ammonium and quaternary phosphonium compounds can also be used to catalyze the reaction. In addition salts and chelates of metals such as aluminum, chromium, zirconium, or zinc may also be used. Catalysts AMC-2 and ATC-3 available from AMPAC Fine Chemicals are chelates of chromium and effective catalyst for acid-epoxy reactions.

In a further embodiment, an EPEFA may undergo a ring-opening reaction with an organic alcohol to introduce hydroxyl functionality and form the corresponding EPEFA polyol. Organic alcohols which may be used include methanol, ethanol, n-propanol, n-butanol, isopropanol, isobutanol, 2-ethyl-1-hexanol, and the like as well as mixtures thereof.

The extent of reaction of the epoxy groups in the EPEFA with organic acid or alcohol may be varied by varying the amount of organic acid or alcohol used in the reaction. For example, as little as 10% or less of the epoxy groups may be reacted up to as much as 100% of the epoxy groups, resulting in polyols having varying degrees of hydroxyl functionality.

In a preferred embodiment, the EPEFA is epoxidized sucrose ester of soybean oil (epoxidized sucrose soyate) and the resulting polyfunctional bio-based polyol is methoxylated sucrose soyate polyol.

In another embodiment, the polyfunctional bio-based polyols are reacted with a polyisocyanate to form a polyurethane coating composition in the same way as conventional polyols known in the art. Any compound having two or more isocyanate groups can be used as a crosslinker. Aromatic, aliphatic, or cycloaliphatic isocyanates are suitable. Examples of isocyanates which can be used for crosslinking the polyols are hexamethylene diisocyanate, isophorone diisocyanate, toluene diisocyanate, methylene diphenyl diisocyanate, meta-tetramethylxylylene diisocyanate and the like. Adducts or oligomers of the diisocyanates are also suitable such as polymeric methylene diphenyl diisocyanate or the biuret or isocyanurate trimer resins of hexamethylene diisocyanate or isophorone diisocyanate. Adduct polyisocyanate resins can be synthesized by reacting a polyol with a diisocyanate such that unreacted isocyanate groups remain. For example, one mole of trimethyolopropane can be reacted with three moles of isophorone diisocyanate to yield an isocyanate functional resin.

Catalysts known in the art may be used to increase the curing speed of the polyfunctional bio-based polyols with a polyisocyanate to form polyurethane. Salts of metals such as tin, bismuth, zinc and zirconium may be used. For example, dibutyl tin dilaurate is a highly effective catalyst for polyurethane formation. Tertiary amines may also be used as a catalyst for urethane formation as is known in the art, such as for example, triethyl amine, DABCO [1,4-diazabicyclo[2.2.2]octane], and the like.

In one embodiment, any cellulose-based bast natural fiber may be combined with the polyurethanes to make the structural biocomposites of the invention. Cellulose-based bast natural fibers that may be used include, but are not limited to, flax, ramie, hemp, jute, kenaf, roselle, sunn hemp, urena, abutilon, abutilon theophrasti, cotton, rayon, modal, and lyocell. Preferably, flax fibers are used to make the structural biocomposites of the invention. Preferably, the natural fibers that may be used in the invention are high in cellulose content, are cleaned of dirt and debris, are separated into fine fibers rather than coarse bundles, and/or are low in moisture content. Without wishing to be bound by any particular scientific theory, some natural affinity exists between cellulose-based bast natural fibers and the bio-based polyurethanes, which creates strong interfacial properties with little surface treatment to the natural fibers. In contrast, most natural fibers require a high degree of mechanical and/or chemical treatment to promote improved adhesion when combined with most petrochemical-based resins in a structural biocomposite.

In another embodiment, any glass fiber, such as, for example, S-glass fibers, C-glass fibers, E-glass fibers, and mixtures thereof, may be combined with the polyurethanes to make the structural biocomposites of the invention. As one of skill in the art would understand, the “S,” “C,” and “E” designate different concentrations of SiO₂, Al₂O₃, CaO, MgO, B₂O₃, and Na₂O. For example, S-glass fibers have a typical nominal composition of SiO₂ 65 wt %, Al₂O₃ 25 wt %, and MgO 10 wt %, whereas E-glass fibers have a typical nominal composition of SiO₂ 54 wt %, Al₂O₃ 14 wt %, CaO+MgO 22 wt %, B₂O₃ 10 wt %, and Na₂O+K₂O less then 2 wt %. Some other materials may also be present at impurity levels. Different concentrations of these compounds produce different fiber properties, such as, for example, strength, modulus, corrosion resistance, etc. For example, S-glass fibers typically have a density of 2.49 g/cm³, tensile strength of 4750 MPa, and a Young modulus of 89 GPa, whereas E-glass fibers have a density of 2.55 g/cm³, tensile strength of 2000 MPa, and a Young modulus of 80 GPa.

In one embodiment, the cellulose-based bast natural fibers and/or glass fibers may be present in the biocomposite of the invention in an amount ranging from 20 to 60 vol. %, more preferably, 30 to 50 vol. %, even more preferably 35 to 40 vol. %, based on the total amount of fiber and polyurethane. In some biocomposites of the invention, the higher the natural fiber and/or glass fiber loading the stronger, stiffer, and/or more brittle the properties may become.

Hydroxy functional compounds can serve as diluent resins in coating compositions comprising the structural biocomposites of the invention. These can include alcohols such as butanol, 2-ethyl hexanol, 1,4-cyclohexanedimethanol, 1,3-cyclohexanedimethanol and the like. Polymeric polyols can also be used as diluents. These can be polyether polyols such as polyethylene glycols, polypropylene glycols, polytetramethylene diols. Polyester polyols such as polycaprolactones can also be incorporated as diluents. Other bio-based polyols may also be used as well, including soy polyols, such as, for example, Agrol Polyols manufactured by Biobased Technologies, Inc., BioOH manufactured by Cargill, Inc., and the like.

In one embodiment, the structural biocomposites of the invention may be made by, first, reacting at least one polyfunctional bio-based polyol with at least one polyisocyanate, and, optionally a catalyst to make a polyurethane, and, second, combining the polyurethane with at least one cellulose-based bast natural fiber, at least one glass fiber, or mixtures thereof to make the structural biocomposite.

### Examples

### 1.1 Material Preparation

Two types of fiber reinforcement and one type of polyurethane (PU) matrix were prepared. Specifically, two composites: (1) 50% vol. glass/bio-based PU, and (2) 40% vol. flax/bio-based PU were prepared. The high functionality methoxylated sucrose soyate polyol (MSSP) was prepared by epoxide ring-opening reactions from epoxidized sucrose ester of soybean oil—epoxidized sucrose soyate—in which secondary hydroxyl groups were generated from epoxides on fatty acid chains in the manner described in Pan et al., “New Biobased High Functionality Polyols and Their Use in Polyurethane Coatings,” ChemSusChem 5:419-429 (2012), which is incorporated herein by reference. This high functionality polyol contained OH eq. wt.=300 g OH eq⁻¹. The isocyanate component was Baydur PUL 2500 Comp. A Isocyanate with an NCO content of 31.5%. The reinforcement used was E-glass fabric with 237 g/cm² and plain weave supplied by Fibre Glast Development Corporation. The mechanical and thermal properties were assessed for this novel bio-based polyurethane and on the synthetic and natural fiber reinforced composites to confirm that they have desirable properties. The tensile, flexural, shear, and impact strength in addition to thermal properties (HDT, T_{g}) of flax and glass fiber reinforced polyurethane derived from sucrose soyate resin composites are disclosed herein.

### 1.2 Composite Preparation

E-glass fibers and flax fibers were dried at 100° C. overnight to prevent void formation. The hand layup technique was used to prepare two fiber reinforced composites: (1) 40 vol. % flax/PU composite, and (2) 50 vol. % glass/PU composite. Each layer of fiber fabric was pre-impregnated by matrix and then placed over the other fabric in the mold to ensure resin is uniformly distributed throughout the composite. Composites were processed in the 100 mm×200 mm dimension closed mold compression at room temperature under 110 kN for 12 hours. To make sure of complete curing, the specimens were put in an oven at 80° C. overnight.

### 1.3 Mechanical Testing

The reinforcement weight fraction was determined by the resin burn-off. The fiber volume fraction was measured from fiber, matrix, and composite density. Completion of the reaction was determined by Differential Scanning calorimetry (DSC). Mechanical and thermal tests were performed to evaluate the matrix and flax and glass reinforced PU composites properties. All mechanical tests were conducted at ambient temperature. Tensile strength and modulus, flexural strength and modulus, impact resistance, and interlaminar shear strength were used to measure static mechanical properties. Dynamic mechanical analysis (DMA) was also used to determine thermal properties of specimens. DMA was carried out on a TA Instrument Dynamic Mechanical Analyzer at a heating rate of 5° C./min from 0 to 190° C. with oscillation frequency of 10 Hz. The following sections provide details on the mechanical property testing that was carried out on neat PU and flax, and glass fiber reinforced bio-based PU composites.

### 2 Results and Discussion

### 2.1 Curing Analysis

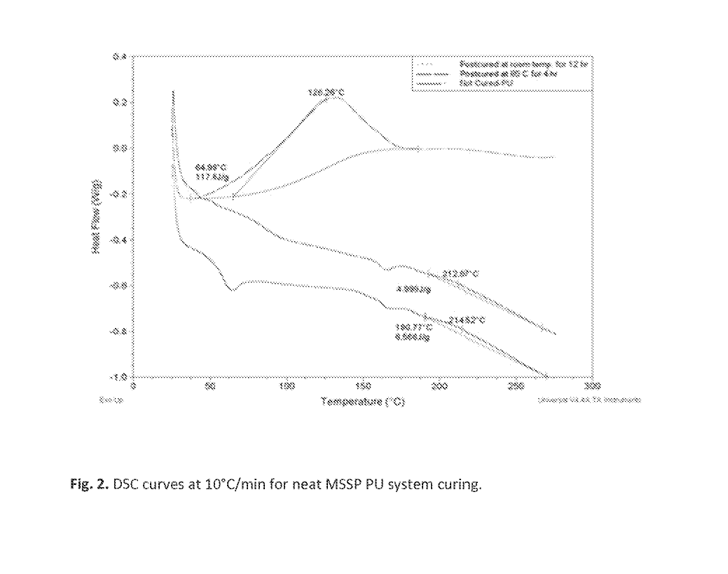

Differential Scanning calorimetry (DSC) is a useful tool for the characterization of curing reactions. Curing reactions are invariably exothermic processes and register in a DSC thermogram as an increase in specific heat (i.e., as an exotherm). The area under such peaks can be measured in terms of calories per gram of sample, and thus the DSC technique is used to obtain curing data with respect to temperature, i.e., the temperature at which a system starts to cure and a range over which it continues. Therefore, DSC verifies that the resin curing reaction was completed before any mechanical tests. A DSC 01000 from TA Instruments with an auto sampler was used to measure the exothermic heat (heat per mass of material, J/g) when samples were subjected to a heat cycle from 0 to 260° C. by ramping at 10° C./min. DSC was started just after preparing the mixture, which is because the total heat of reaction is measured from 0% to 100% conversion. The residual heat was measured after isothermally curing in an oven at 80° C. for 4 hrs and at room temperature for 12 hrs. FIG. 2 shows the DSC for neat MSSP PU system for (1) from the beginning of the reaction, (2) after 4 hrs curing in an oven, and (3) after 12 hrs curing at room temperature. Based on these curves, to complete cure, the PU system requires more than 4 hours of postcuring at 80° C. The degree of cure of PU system can be calculated by Eqn. (1):

αₜ=ΔH_{reaction}−ΔH_{Resedual}/ΔH_{reaction}=ΔHₜ/ΔH_{reaction} (1)

where αₜ denotes the degree of cure at curing time t (hr), ΔHₜ, is the liberated heat during time t. ΔHᵣₑₛ is the residual heat after time t, and ΔHᵣₓₙ is the total heat of reaction. The integrated area of the exothermic peak was determined as the liberated heat in the DSC scan. The total heat of reaction (ΔHᵣₓₙ) and the residual heat after curing (ΔHᵣₑₛ) were obtained. Table 1 presents the degree of cure for neat MSSP PU with postcuring at 80° C. for 4 hrs and at room temperature for 12 hrs.

TABLE 1
The Degree of Cure of MSSP PU Systems

| | | | | Degree of |
|---|---|---|---|---|
| Sample | Curing Condition | ΔH_{residual} | ΔH_{reaction} | Cure |
| Neat MSSP PU | 4 hr at 80° C. | 6.89 | 182.8 | 96.2 |
| Neat MSSP PU | 12 hr at room | 7.09 | 182.8 | 96.1 |
| | temp. | | | |

### 2.2 Tensile Testing

Tensile test specimens were cut from the fabricated panels according to American Society for Testing and Materials (ASTM) standards in a laboratory room environment (23° C., 50% relative humidity) to promote failure in the gage section. Tensile testing (ASTM D3039) was conducted on an Instron Q5567 load frame using a displacement rate of 2 mm/min (0.08 in/min) throughout the investigation. An extensometer was attached to the sample to measure strain in order to calculate the modulus. The tensile properties obtained from the ASTM D3039 testing are shown in Table 2. Tensile strength for composites were not reported in these results as failure of most specimens was outside of the gage section.

TABLE 2
Tensile Test Results for Neat PU, 40 vol. %
Flax/PU, and 50 vol. % Glass/PU Composites

| | Tensile Modulus | Tensile Strength |
|---|---|---|
| Sample | GPa (ksi) | MPa (ksi) |
| Neat PU | 1.41 ± 0.002 | 36.34 ± 1.03 |
| | (205 ± 0.31) | (5.27 ± 0.150) |
| Flax/PU | 26.7 ± 2.56 | 168.7 ± 18.7 |
| | (3872.51 ± 371.3) | (24.47 ± 2.71) |
| Glass/PU | 33.05 ± 3.59 | 525.31 ± 32.81 |
| | (4793.5 ± 520.69) | (76.19 ± 4.76) |

### 2.3 Flexural Testing

The 3-point flexural testing of the neat PU, flax/PU, and glass/PU composites was conducted on the same tensile machine (Instron Q5567 load frame) according to the ASTM standard D790. For all tests, the support span was 16 times the depth of the beam. The minimum overhang length of either side of the supporting rollers was not less than 6.35 mm (¼ in).

Testing was conducted at room temperature on five different samples. Both flexural strength and modulus was determined (Table 3).

TABLE 3
Flexural test results for neat PU, 40 vol. %
Flax/PU, and 50 vol. % Glass/PU composites

| | Flexural Modulus | Flexural Strength |
|---|---|---|
| Sample | GPa (ksi) | MPa (ksi) |
| Neat PU | 1.18 ± 0.18 | 51.55 ± 6.09 |
| | (171.61 ± 26.58) | 7.47 ± 0.88 |
| Flax/PU | 12.38 ± 1.33 | 177.34 ± 14.79 |
| | (1795.52 ± 193.46) | (25.72 ± 2.15) |
| Glass/PU | 36.21 ± 1.4 | 591.90 ± 13.59 |
| | (5251.81 ± 203.05) | (85.85 ± 1.97) |

### 2.4 Interfacial Properties

The interfacial properties of flax/PU composites were evaluated by short beam shear tests (ASTM D2344). The results of short beam shear tests of flax/PU and glass/PU composites are presented in Table 4.

TABLE 4
Interfacial Properties of 40 vol. % Flax/PU
and 50 vol. % Glass/PU composites

| | Interlaminar Shear Strength |
|---|---|
| Sample | MPa (ksi) |
| Flax/PU | 18.29 ± 0.742 |
| | (2.65 ± 0.11) |
| Glass/PU | 40.22 ± 2.11 |
| | (5.83 ± 0.31) |

### 2.5 Izod Impact Test (ASTM 256)

The test specimen for Izod impact is clamped into position so that the notched end of the specimen is facing the striking edge of the pendulum. The pendulum hammer is released, allowed to strike the specimen, and swing through. If the specimen does not break more weight is added to the hammer and the test is repeated until failure occurs. The impact values are directly read from the scale. Tinius Olsen impact testing machine used for measuring impact toughness. Assuming negligible friction and aerodynamic drag, the energy absorbed by the specimen was equal to the height difference times the weight of the pendulum. The mean impact toughness for neat PU, flax/PU, and glass/PU composite specimens are shown in Table 5.

TABLE 5
Unnotched impact toughness of neat PU, 40 vol.
% Flax/PU, and 50 vol. % Glass/PU composites

| | Impact Resistance |
|---|---|
| Sample | J/m (ft · lb/in) |
| Neat PU | 87.54 ± 33.62 |
| | (1.64 ± 0.63) |
| Flax/PU | 587.3 ± 36.37 |
| | (11.0 ± 0.68) |
| Glass/PU | 3933.55 ± 318.98 |
| | (73.56 ± 5.96) |

### 2.6 T_{g} by DMA

Dynamic mechanical tests were carried out on a dynamic mechanical analyzer (DMA). The loss moduli and tan δ were recorded from 25° C. to 180° C., at the heating rate of 5° C./min (Table 6).

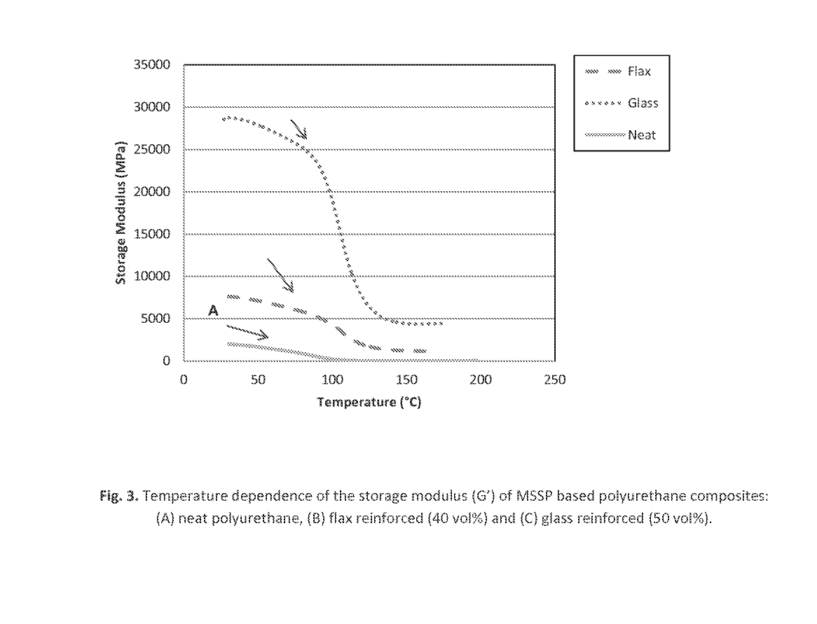

A typical plot of the temperature dependence of the storage modulus (G′) of the high functionality soy polyol-based polyurethane and its composites is shown in FIG. 3. The value of G′ was initially stable at low temperature (glassy state). Then, it sharply drops in the region between 70 and 130° C. As the temperature further increased, G′ stabilized in the rubbery state. The presence of a region where the storage modulus remains relatively constant indicates that a stable crosslinked network exists. The patterns of the curves of temperature dependence for the composite specimens are similar in nature to the neat polyurethane. However, over the temperature range studied, G′ is noticeably increased in the flax and especially glass composites. The substantial increase in G′ in composites is attributed to fiber loading and stress transfer at the matrix-fiber interface, thereby increasing the stiffness of the overall material.

A comparison of the average G′ values measured at 40° C. is shown in FIG. 3. At this temperature, G′ increased from an average of 7500 MPa in 40 vol. % flax fiber reinforced with MSSP based polyurethane to 28750 MPa in the 50 vol. % glass fiber reinforced with MSSP based polyurethane. These values represent significant improvements compared to the neat MSSP based polyurethane (1875 MPa).

The glass transition temperatures (T_{g}) were determined from the peak of the tan 6 (ratio of loss modulus, G″, to storage modulus, G′) curves. Only one T_{g} (112.11±1.8) was observed for the polyurethane suggesting a single phase system. The high T_{g} of these composites containing sucrose soyate was attributed to the great structural rigidity and the high functionality of the sucrose molecule which is the core of sucrose soyate. The rigidity of the sucrose molecule has been shown to give more rigid thermosets in previous studies.^{2,18}

Flax/PU exhibited higher glass transition temperature than the glass/PU composites. However the error bars overlap, thus indicating that glass transition temperature may be the same in both the flax and glass composites. Considering fiber loading that is 25 vol. % less in flax fiber compared to glass fiber, the T_{g} of this bio-based polyurethane shifted to higher values and was determined to be 117.31±0.58° C. for the flax-reinforced composite if considering the error bar, no increase was noticed when E-glass was used as reinforcement (114.31±2.8° C.).

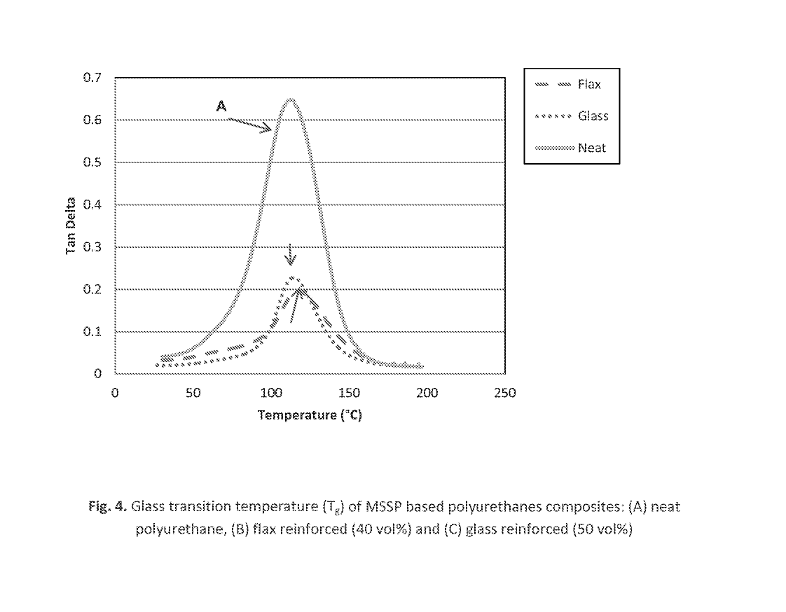

The increase in T_{g} for the flax/PU composites suggests a restricted mobility of polymer chains in the network. This may be the result of the increased number of hydroxyl groups available on the flax fiber. Those groups react with isocyanate and result in immobilization of polyurethane molecules on fibers. The intensity of tan 6 decreases in composites due to the net volume reduction of the polyurethane resin but also as a result of the lower chain mobility (FIG. 4).

TABLE 6
T_{g} for neat PU, 40 vol. % Flax/PU,
and 50 vol. % Glass/PU composites

| Sample | Tg ° C. (° F.) |
|---|---|
| Neat PU | 112.11 ± 1.8 |
| | (233.79 ± 3.24) |
| Flax/PU | 117.31 ± 0.58 |
| | (243.16 ± 1.04) |
| Glass/PU | 114.31 ± 2.8 |
| | (250.18 ± 5.04) |

### 2.7 Heat Deflection Temperature

The heat distortion temperature (HDT), usually denotes the highest temperature to which a polymer may be used as a rigid material in application, which is why HDT sometimes is referred to as softening temperature. Up to this maximum temperature (HDT), a material is able to support a load for some appreciable time. Heat distortion temperature was determined using a dynamic mechanical analyzer (DMA) using a three-point bending fixture. According to ASTM International Standard D 648, the samples were heated from 25° C. temperature to 300° C. at the rate of 3° C./min. Table 7 shows the HDT for neat PU, the flax/PU composite, and glass/PU composite.

TABLE 7
HDT for neat PU, 40 vol. % Flax/PU,
and 5 vol. % Glass/PU composite

| Sample | HDT ° C. (° F.) |
|---|---|
| Neat PU | 68.8 ± 1.8 |
| | (155.84 ± 3.24) |
| Flax/PU | 243.67 ± 6.03 |
| | (470.61 ± 10.85) |
| Glass/PU | 274.32 ± 2.8 |
| | (525.78 ± 5.04) |

### 2.8 Results and Discussion

The static mechanical properties (i.e., tensile strength, flexural strength, and impact strength) and thermal properties (HDT, T_{g}) were investigated for 40 vol. % flax/PU and 50 vol. % glass/PU composite. Although the volume fraction of flax fiber was lower than fiberglass reinforced composites, they exhibited comparable thermal properties to the fiberglass reinforced composites. By considering the lower volume fraction of flax in composites, they were also found to exhibit mechanical properties comparable to that of a commercially available fiberglass/PU composite.

The claimed invention is:

1. A structural biocomposite, comprising:
a) at least one cellulose-based bast natural fiber, at least one glass fiber, or mixtures thereof; and
b) at least one polyurethane,
wherein said polyurethane comprises the reaction product of at least one polyfunctional bio-based polyol and at least one polyisocyanate, and, optionally a catalyst.

2. The structural biocomposite of claim 1, wherein the cellulose-based bast natural fiber is selected from flax, ramie, hemp, jute, kenaf, roselle, sunn hemp, urena, abutilon, abutilon theophrasti, and mixtures thereof.

3. The structural biocomposite of claim 2, wherein the cellulose-based bast natural fiber is flax.

4. The structural biocomposite of claim 1, wherein the glass fiber is selected from S-glass fibers, C-glass fibers, E-glass fibers, or mixtures thereof.

5. The structural biocomposite of claim 1, wherein the at least one cellulose-based bast natural fiber, at least one glass fiber, or mixtures thereof is present in amount ranging from 20 to 60 vol. %.

6. The structural biocomposite of claim 1, wherein the polyfunctional bio-based polyol is selected from a polyol ester of fatty acid.

7. The structural biocomposite of claim 6, wherein the polyol ester of fatty acid is methoxylated sucrose soyate.

8. The structural biocomposite of claim 6, wherein the polyol ester of fatty acid comprises the reaction product of an epoxidized polyol ester of fatty acid and an organic acid or an organic alcohol.

9. The structural biocomposite of claim 8, wherein the epoxidized polyol ester of fatty acid is epoxidized sucrose soyate.

10. The structural biocomposite of claim 1, wherein the polyisocyanate is selected from an aromatic isocyanate, an aliphatic isocyanate, a cycloaliphatic isocyanate, and mixtures thereof.

11. The structural biocomposite of claim 1, wherein the catalyst is selected from tin salts, bismuth salts, zinc salts, zirconium salts, tertiary amines, and mixtures thereof.

12. A method of making a structural biocomposite comprising the steps of:
a) reacting at least one polyfunctional bio-based polyol with at least one polyisocyanate, and, optionally a catalyst to make a polyurethane; and
b) combining the polyurethane with at least one cellulose-based bast natural fiber, at least one glass fiber, or mixtures thereof to make the structural biocomposite.

13. The method of claim 12, wherein the polyfunctional bio-based polyol is selected from a polyol ester of fatty acid.

14. The method of claim 13, wherein the polyol ester of fatty acid is methoxylated sucrose soyate.

15. The method of claim 13, wherein the polyol ester of fatty acid comprises the reaction product of an epoxidized polyol ester of fatty acid and an organic acid or an organic alcohol.

16. The method of claim 15, wherein the epoxidized polyol ester of fatty acid is epoxidized sucrose soyate.

17. The method of claim 12, wherein the polyisocyanate is selected from an aromatic isocyanate, an aliphatic isocyanate, a cycloaliphatic isocyanate, and mixtures thereof

18. The method of claim 12, wherein the catalyst is selected from tin salts, bismuth salts, zinc salts, zirconium salts, tertiary amines, and mixtures thereof.

19. The method of claim 12, wherein the cellulose-based bast natural fiber is selected from flax, ramie, hemp, jute, kenaf, roselle, sunn hemp, urena, abutilon, abutilon theophrasti, and mixtures thereof.

20. The method of claim 19, wherein the cellulose-based bast natural fiber is flax.

21. The method of claim 12, wherein the glass fiber is selected from S-glass fibers, C-glass fibers, E-glass fibers, or mixtures thereof.

22. The structural biocomposite of claim 12, wherein the at least one cellulose-based bast natural fiber, at least one glass fiber, or mixtures thereof is present in amount ranging from 20 to 60 vol. %.
